(19) United States
(12) Patent Application Publication
(10) Pub. No.: US 2003/0112141 A1
(43) Pub. Date: Jun. 19, 2003

(54) Method and system for providing emergency information from a communication device outside a vehicle

(75) Inventor: Uma Arunkumar, Novi, MI (US)

Correspondence Address: General Motors Corporation, Legal Staff, Mail Code 482-C23-B21, 300 Renaissance Center, P.O. Box 300, Detroit, MI, 48265-3000, US

(73) Assignee: General Motors Corporation

(21) Appl. No.: 10/021,704

(22) Filed: Dec. 13, 2001

(51) Int. Cl. B60R 25/10

(52) U.S. Cl. 340/539.18; 340/425.5

(57) ABSTRACT

The present invention provides a system, a method and a computer usable medium including a program for providing emergency information from a communication device outside a vehicle. This may be done by transmitting an encoded emergency information signal from a communication device located outside of a vehicle to onboard vehicle receiver. It may also be done by sending the encoded emergency information from the onboard receiver to the onboard communication relay device, by transmitting the encoded emergency information signal from the onboard communication relay device to a call center and by decoding the emergency information signal received at the call center.

### FIELD OF THE INVENTION

This invention relates generally to the navigation of a moving vehicle. In particular, this invention relates to a method and system for providing emergency information from a communication device outside a vehicle.

### BACKGROUND OF THE INVENTION

Wireless technology has advanced to the point where it is reliable and can be used in emergency situations. One example is an emergency alert system which has become a popular system of choice for use by elderly people or persons with chronic illnesses that warrant summoning emergency services.

These systems tend to be home based systems and operate over an existing “land based” communication network. To facilitate summoning emergency services while away from the home it is necessary to develop a wireless emergency alert system. One example is an emergency alert system located in a vehicle. This system, initiated by pressing a button within the vehicle, summons emergency services, for example, the police department, with the assistance of a live operator.

This system does not address the situation where emergency services are needed when the user is outside of the vehicle. Many systems provide the capability of turning on an audio alarm locally on the vehicle, however this alarm is not linked with emergency services.

It would be desirable therefore to provide a system that overcomes the above limitations for providing emergency information from a communication device outside a vehicle.

### SUMMARY OF THE INVENTION

One aspect of the present invention provides a method for providing emergency information from a communication device outside a vehicle. An encoded emergency information signal is transmitted from a communication device located outside of a vehicle to onboard vehicle receiver, the encoded emergency information is then sent to the onboard communication relay device and then transmitted via a cellular communication network to a call center. The emergency information is then decoded at the call center.

Another aspect of the present invention provides a system for providing emergency information from a communication device outside a vehicle. The system may include means for transmitting an encoded emergency information signal from a communication device located outside of a vehicle to onboard vehicle receiver and sending the encoded emergency information from the onboard receiver to the onboard communication relay device. It may also include means for transmitting the encoded emergency information signal from the onboard communication relay device to a call center via a cellular communication network and means for decoding the emergency information signal received at the call center.

Another aspect of the present invention provides a computer usable medium including a program for providing emergency information from a communication device outside a vehicle. The program may include computer readable program code that transmits an encoded emergency information signal from a communication device located outside of a vehicle to onboard vehicle receiver and computer readable program code that sends the encoded emergency information from the onboard receiver to the onboard communication relay device. The program may also include computer readable program code that transmits the encoded emergency information signal from the onboard communication relay device to a call center and computer readable program code that decodes the emergency information signal received at the call center.

The foregoing and other features and advantages of the invention will become further apparent from the following detailed description of the presently preferred embodiments, read in conjunction with the accompanying drawings. The detailed description and drawings are merely illustrative of the invention rather than limiting, the scope of the invention being defined by the appended claims and equivalents thereof.

### BRIEF DESCRIPTION OF THE DRAWINGS

FIG. 1 is a schematic diagram of a system for providing emergency information from a communication device outside a vehicle in accordance with the present invention;

FIG. 2 is a schematic diagram of another embodiment of a system for providing emergency information from a communication device outside a vehicle in accordance with the present invention;

FIG. 3 shows a flow diagram of one embodiment of a method for providing emergency information from a communication device outside a vehicle in accordance with the present invention; and

FIG. 4 is a schematic diagram, illustrating one embodiment of a method for providing emergency information from a communication device outside a vehicle in accordance with the present invention.

### DETAILED DESCRIPTION OF THE PRESENTLY PREFERRED EMBODIMENTS

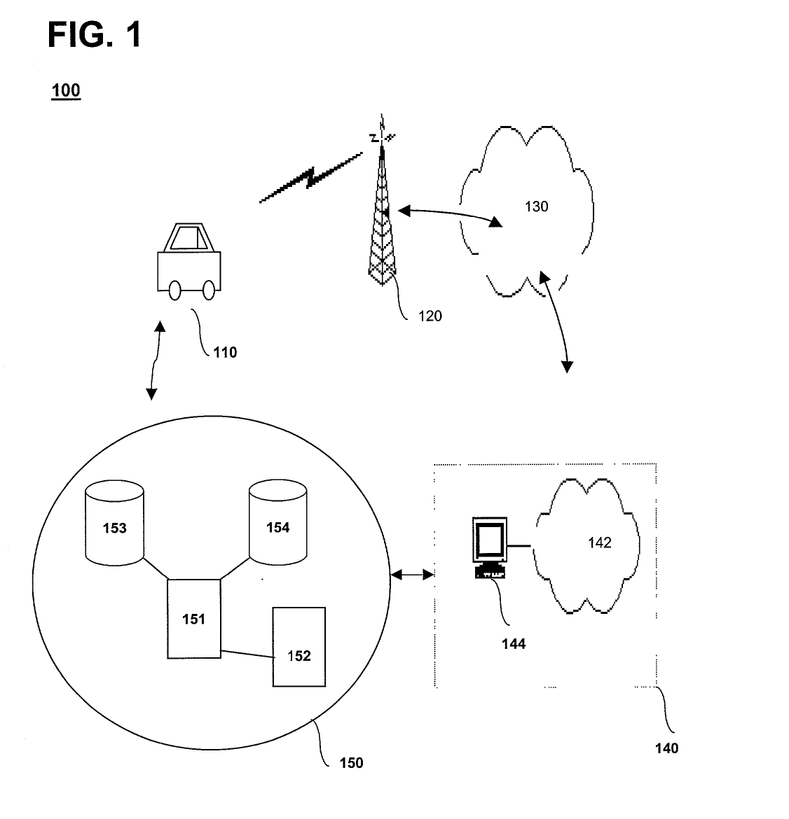

Referring now to the drawings wherein like elements have like reference numbers. FIG. 1 shows one embodiment of a system for providing emergency information from a communication device outside a vehicle in accordance with the present invention at 100. The system may include one or more vehicle clients 110, one or more carrier systems 120, one or more communication networks 130, one or more service management subsystems 140, and one or more navigation subsystems 150. The service management subsystems may include one or more service management applications 142 and one or more service managers 144. The navigation subsystem 150 may include of one or more route applications 151, 152 and one or more coordinate databases 153, 154.

Navigation subsystem 150 may be a system for generating routes to be delivered to vehicle client 110 and for receiving route information from vehicle client 110. Navigation subsystem 150 may be connected with or in communication with service management subsystem 140. Service management subsystem 140 may be used to manage the delivery of information to or from navigation subsystem 150 to other parts of system 100. Routes may be delivered or information may be received via a live agent, such as a human advisor, or via a virtual agent, such as an interactive computer program.

Navigation subsystem 150 may be any suitable hardware or software configuration, or combination of hardware and software that is configured to generate a route, process route information or receive information from vehicle client 110. In one embodiment of the invention, navigation subsystem 150 comprises one or more route applications 151, 152 and one or more coordinate databases 153, 154. For example, route applications 151, 152 may be any suitable software application for generating route information or otherwise processing route information. Coordinate databases 153, 154 may be any suitable databases for storing route information, such as location coordinates.

Vehicle client 110 may be any suitable vehicle. For example, the vehicle may be an automobile or a passenger-carrying unit such as a bus or train. Alternatively, vehicle client 110 may be an occupant of the vehicle or any suitable client device contained in the vehicle. In one embodiment of the invention, vehicle client 110 is a mobile or portable device equipped to communicate with service management subsystem 140. Carrier system 120 may be any suitable system for transmitting a signal from vehicle 110 to service management subsystem 140. Carrier system 120 may also transmit a signal from service management subsystem 140 to vehicle client 110. In one embodiment of the invention, carrier system 120 may be a wireless carrier system as is well known in the art. Carrier system 120 may be, for example, a transmitter/receiver unit attached to vehicle client 110. Alternatively, carrier system 120 may be a separate transmitter/receiver carried by vehicle client 110.

Communication network 130 is any suitable system for communicating between vehicle client 110 and service management subsystem 140. In one embodiment of the invention, communication network is a public switched telephone network (PSTN). Alternatively, communication network 130 may be a multiprotocol Internet or Intranet capable of transmitting voice and/or data in either analog or digital form or a combination of both. Alternatively, communication network 130 may be a hybrid communication network or virtual network.

Service management subsystem 140 is a system for managing a variety of services to be delivered to or from vehicle client 110. In one embodiment of the invention, service management subsystem 140 manages services that can be distributed over a variety of channels. For example, services may be delivered via a live agent, such as a human advisor, or via a virtual agent, such as an interactive computer program. The structure of service management subsystem 140 may enable services to be delivered in a uniform manner regardless of the channel used for delivery or of the service being delivered. Service management subsystem 140 may maintain a consistent subscriber experience and “look and feel” across the products being delivered across the service distribution channels enabled.

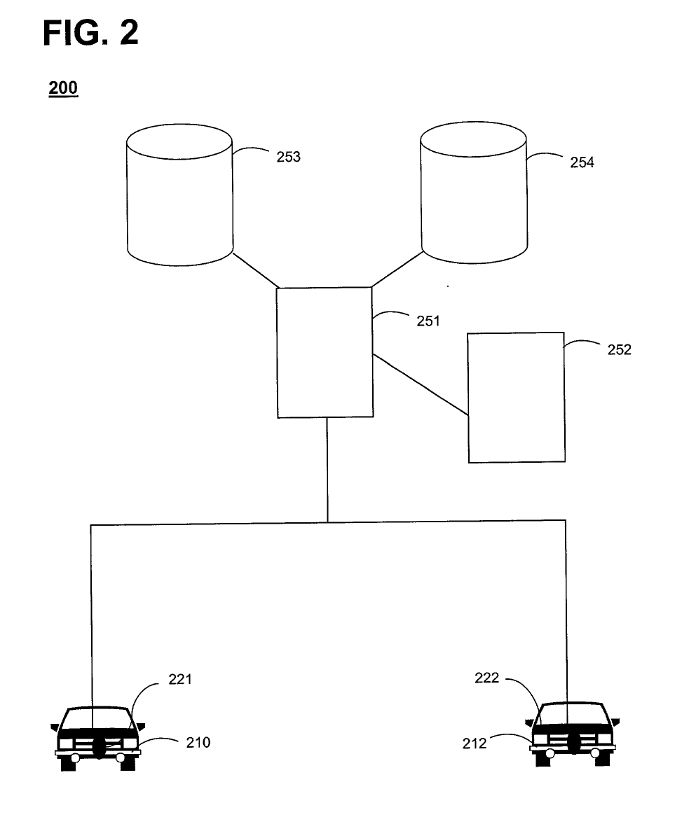

FIG. 2 shows one embodiment of a method for providing emergency information from a communication device outside a vehicle in accordance with the present invention at 200. Navigation system 200 may include one or more navigation clients 210, 212. Each navigation client 210, 212 may have an in-vehicle navigator 221, 222. Navigation system 200 may also include one or more route generation applications 251, 252. Navigation system 200 may also include one or more coordinate databases 253, 254.

Navigation clients 210, 212 may be one or more vehicle clients as described above.

In-vehicle navigator 221, 222 may be any suitable component of navigation client 210, 212, which may be used to navigate vehicle client 210, 212. For example, in-vehicle navigator 221, 222 may be a driver. Alternatively, in-vehicle navigator 221, 222 may be an automatic system for navigating vehicle 210, 212.

Route generation applications 251, 252 may be any suitable application for calculating maneuver lists of directions between one or more locations. For example, route generation applications 251, 252 may be any suitable software or hardware programs for managing or calculating routes, portions of route or route coordinates. Route generation applications may include or be able to calculate routes from navigation client's current location to private residences, businesses or recreational facilities. In one embodiment of the invention, route generation applications 251, 252 are in communication with coordinate databases 253, 254.

Route generation applications 251, 252 may generate navigation information in any suitable manner. For example, route generation applications 251, 252 may generate routes using geocoding. That is, the application 251, 252 determines a corresponding latitude and longitude based on an input navigation address. Alternatively, route generation applications 251, 252 may generate routes using reverse geocoding. That is, the application 251, 252 determines a corresponding navigation address based on input latitude and longitude coordinates.

Coordinate databases 253, 254 may be any suitable databases for storing such location coordinates as latitude and longitude of a variety of locations. These locations may be, for example, points of interest. Coordinate databases 253, 254 may also be a database of street addresses. Coordinate databases 253, 254 may also be a database of routes between points.

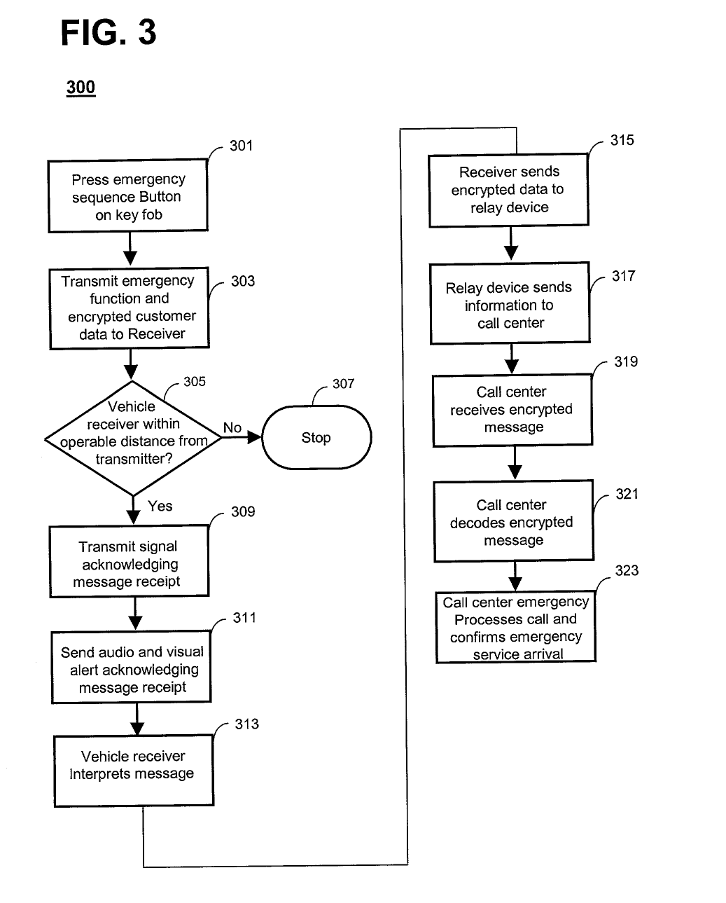

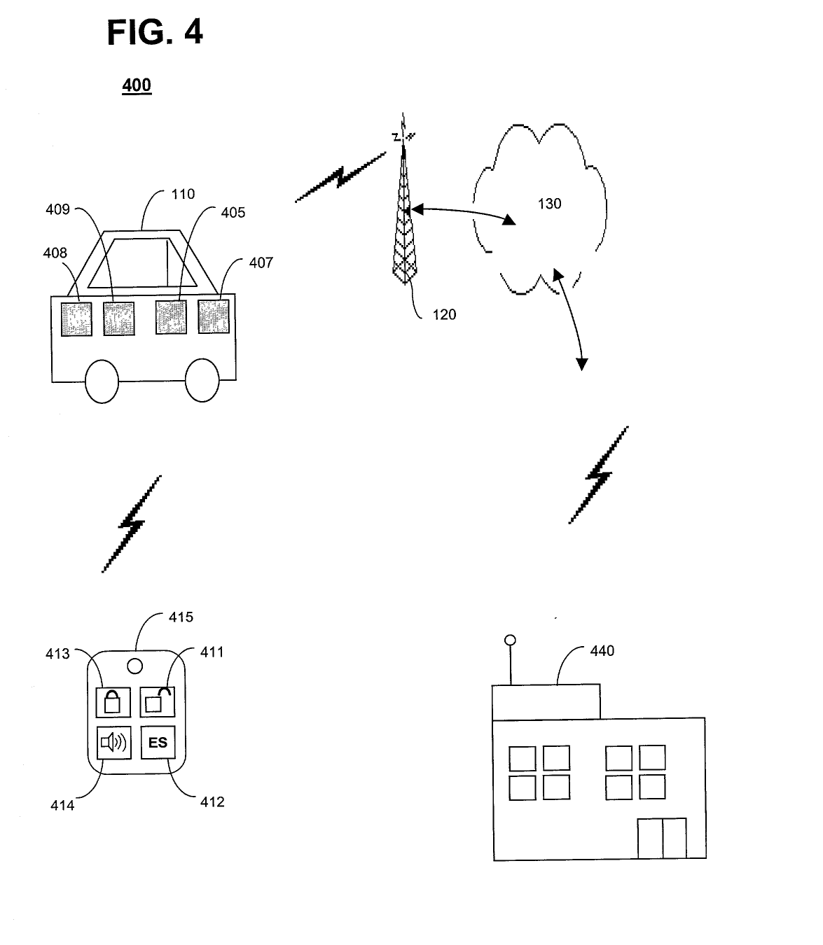

Referring now to FIGS. 3 and 4. FIG. 3 shows a flow diagram of one embodiment of a method for providing emergency information from a communication device outside a vehicle in accordance with the present invention at 300. FIG. 4 shows a schematic diagram illustrating one embodiment of a method for providing emergency information from a communication device outside a vehicle in accordance with the present invention at 400.

In one embodiment the communication device may be a wireless remote electronic key fob 415 which may include a button 411 to unlock the vehicle 110, a button 413 to lock the vehicle, a panic button 414 and an emergency sequence button 412. The emergency sequence button 412 may be pressed to initiate the emergency sequence (block 301). A radio frequency signal, including the emergency function and encoded customer data may be transmitted from the electronic key fob 415 to a vehicle receiver 405 (block 303). The vehicle receiver may be a radio frequency based device and may receive and direct radio frequency signals transmitted by the vehicle key fob. It may then be determined if the vehicle receiver 405 is within a predetermined operable distance from the key fob 415. (block 305) and if it is not within an operable distance, the signal may not be transmitted and the emergency sequence may be stopped (block 307). If the vehicle 110 is within the predetermined operable distance, the signal may be transmitted to the vehicle receiver 405 and the receiver may transmit a confirmation of receipt message to other control modules on the vehicle, for example, the vehicle horn control module 408 and the headlight control module 409. (block 309). After receiving an emergency signal, the vehicle receiver 405 may send instructions to the vehicle horn control module 408 and the headlight control module 409 to sound the vehicle horn and flash the headlights, respectively, to confirm that the signal has been received from the key fob 415 (block 311). The vehicle receiver 405 may determine whether the received message from the key fob 415 is a door lock, door unlock, panic or an emergency sequence signal (block 313). If it determined that the signal is an emergency signal, the vehicle receiver 405 may send the encoded data to an onboard relay device 407 (block 315). The relay device 407 may send the encoded signal to a call center 440 via the cellular network 130 and a tower antenna 120 (block 317). Call center 440 may be a navigation system support center staffed with human or virtual agents and may include the service management subsystem 140. The call center 440 service management subsystem 140 may receive an emergency sequence signal along with the encoded message (block 319) and may decode the message and may extract the customer ID, the vehicle details and the vehicle location (block 321). After receiving this information a call center operator (human advisor) may contact appropriate fire, police and hospital resources nearest to the vehicle 110 location. After a predetermined period following the emergency services dispatching, the call center 440 operator may contact the vehicle 110 to confirm arrival of emergency services (block 323).

While the embodiments of the invention disclosed herein are presently considered to be preferred, various changes and modifications can be made without departing from the spirit and scope of the invention. The scope of the invention is indicated in the appended claims, and all changes that come within the meaning and range of equivalents are intended to be embraced therein.

We claim:

1. A method for providing emergency information from a communication device outside a vehicle comprising:
transmitting an encoded emergency information signal from a communication device located outside of a vehicle to an onboard vehicle receiver;
sending the encoded emergency information from the onboard vehicle receiver to an onboard communication relay device;
transmitting the encoded emergency information signal from the onboard communication relay device to a call center; and
decoding the emergency information signal received at the call center.

2. The method of claim 1, wherein transmitting an emergency information signal from outside of the vehicle comprises pressing an emergency sequence button on a key fob device.

3. The method of claim 1, further comprising transmitting an audible and visual vehicle alert acknowledging receipt of emergency information signal.

4. The method of claim 3, wherein transmitting an audible and visual vehicle alert comprises turning the vehicle's headlights on and off and sounding the vehicle's horn.

5. The method of claim 1, wherein transmitting emergency information to the onboard vehicle receiver comprises:
interpreting an encoded data message and sending it to the communication relay device.

6. The method of claim 5, wherein interpreting an encoded data message comprises determining if the message received by the onboard vehicle receiver is an emergency signal.

7. The method of claim 1, wherein transmitting customer and emergency information to a call center comprises contacting the call center and sending a message with customer ID and vehicle location.

8. The method of claim 1, further comprising contacting the vehicle client to confirm receipt of emergency services.

9. A computer usable medium including a program for providing emergency information from a communication device outside a vehicle comprising:
computer readable program code that transmits an encoded emergency information signal from the communication device located outside of a vehicle to onboard vehicle receiver;
computer readable program code that sends the encoded emergency information from the onboard receiver to the onboard communication relay device;
computer readable program code that transmits the encoded emergency information signal from the onboard communication relay device to a call center; and
computer readable program code that decodes the emergency information signal received at the call center.

10. The computer usable medium of claim 9, wherein transmitting the emergency information signal from outside of the vehicle comprises pressing an emergency sequence button on a key fob device.

11. The computer usable medium of claim 9, further comprising:
computer readable program code that transmits an audible and visual vehicle alert acknowledging receipt of emergency information signal.

12. The computer usable medium of claim 11, wherein transmitting the audible and visual vehicle alert comprises turning the vehicle's headlights on and off and sounding the vehicle's horn.

13. The computer usable medium of claim 9, wherein transmitting emergency information to the onboard vehicle receiver comprises:
interpreting an encoded data message and sending it to the communication relay device.

14. The computer usable medium of claim 13, wherein interpreting the encoded data message comprises:
determining if the message received by the onboard vehicle receiver is an emergency signal.

15. The computer usable medium of claim 9, wherein transmitting emergency information to a call center comprises:
contacting the call center and sending a message with customer ID and vehicle location.

16. The computer usable medium of claim 9, further comprising:
computer readable program code that contacts the vehicle client to confirm receipt of emergency services.

17. A system for providing emergency information from a communication device outside a vehicle comprising:
means of transmitting an encoded emergency information signal from a communication device located outside of a vehicle to an onboard vehicle receiver;
means for sending the encoded emergency information from the onboard vehicle receiver to an onboard communication relay device;
means for transmitting the encoded emergency information signal from the onboard communication relay device to a call center; and
means for decoding the emergency information signal received at the call center.

18. The system of claim 17, further comprising:
means for transmitting an audible and visual vehicle alert acknowledging receipt of emergency information signal.

19. The system of claim 17, further comprising:
means for contacting the vehicle to confirm receipt of emergency services.
